(19) United States
(12) Patent Application Publication
(10) Pub. No.: US 2002/0050367 A1
(43) Pub. Date: May 2, 2002

(54) Crank gear for an electro-pneumatic percussion mechanism of an electrical hand-held power tool

(76) Inventor: Erwin Manschitz, Germering (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/906,972

(22) Filed: Jul. 17, 2001

(30) Foreign Application Priority Data
Jul. 18, 2000 (DE) 100 34 795.9

(51) Int. Cl. B25D 9/00

(52) U.S. Cl. 173/216

(57) ABSTRACT

A crank gear for pneumatic percussion mechanism of an electrical hand-held power tool and including a shaft (3, 14), and at least one radial rolling bearing (6, 6¹) for supporting the shaft (3, 14), with a radial partial region of the shaft (3, 14), which is located within an axial support region (2), forming an inner bearing ring (5, 5¹, 18) of the at least one radial rolling bearing (6, 61) and defining at least one support element, and with a radial interlocking of the at least one support element of the shaft (3, 4) with at least one additional element (8, 11, 15) providing for at least one additional function.

### BACKGROUND OF THE INVENTION

1. Field of the Invention

The present invention relates to an electrical hand-held tool, such as a hammer drill or chisel hammer, having and electropneumatic percussion mechanism, and in particular, to a crank gear for the percussion mechanism and which provides for imparting, at least partially, of a percussion movement to a working tool received in a chuck of the electrical hand-held power tool.

2. Description of the Prior Art

In electrical hand-held power tools including an electropneumatic percussion mechanism, a rotational movement produced by an electrical drive is converted in a reciprocating movement of a driving or percussion piston that imparts, via a gas spring, axial blows to a working tool. One of the possibilities of the conversion of a rotational movement of an electrical drive into a reciprocating movement of a driving or percussion piston and to which the present invention is limited, consists in the use of a crank gear including a rotatable crank shaft and an eccentric journal provided on an eccentric portion of the crank shaft and connected with a connecting rod rotatable by the eccentric journal.

In such crank gears, both the connecting rod, via the eccentric journal, and the rolling support means of the drive pinion apply high radial forces to the crank shaft which should be absorbed by supports arranged in the housing of the hand-held power tool. In turn, the supports or bearings are subjected to the action of bending torques which are determined by a distance between the force application points and the supports.

German Publication DE 39 36 849 describes a crank gear in which a crank shaft is supported at two spaced from each other points in radial rolling bearings and is driven by a drive shaft pinion that engages a tooth gear provided on the free end of the crank shaft. The tooth gear, which is formed as an eccentric section of the crank shaft, includes an eccentrically offset, axially extending eccentric journal that engages in a connecting rod of a percussion mechanism. The drawback of the disclosed crank gear consists in that the forces acting on the eccentric journal impart, via a long lever arm, high bending torques to the radial rolling bearings.

German Publication DE 35 05 544 discloses likewise a crank gear in which a crank shaft is supported at two spaced from each other points in radial rolling bearings and is driven by a drive shaft pinion engaging a tooth gear. An eccentric section of the crank shaft is formed as a crank provided at the free end of the crank shaft, and an eccentrically offset eccentric journal is arranged on the crank. The radial rolling bearing, which is located adjacent to the eccentric journal, is formed as a ball bearing. The drawback of the crank gear disclosed in the German Publication DE 35 05 544 consists in that the necessary large axial length of the crank gear, which is required to form the eccentric section and a resulting elongate lever arm lead to application of high bending torques to the radial bearings.

In European publication EP 583 710A1 and German Publication DE 43 00 021 A1, the crank shaft, which is driven by a tooth gear, has, respectively, a pot shape and a sleeve shape. The crank shaft is supported with needle bearings arranged in the crank shaft interior and supported on axial journals fixedly connected with the power tool housing. The first bearing is arranged in the plane of the tooth gear, and the second bearing is arranged adjacent adjacent to the end side eccentric section that includes and axially extending radially eccentrically offset, eccentric journal.

An object of the present invention is to provide a crank gear for pneumatic percussion mechanism of an electrical hand-held power tool and in which is a small bending torque is applied to the crank shaft supports.

Another object of the present invention, is to provide a crank gear for a pneumatic percussion mechanism of an electrical hand-held power tool and which would have a reduced, in comparison with conventional crank gears, axia length.

### SUMMARY OF THE INVENTION

These and other objects of the present invention, which will become apparent hereinafter, are acrieved by providing a crank gear that includes a shaft, and at least one radial rolling bearing for supporting the shaft, with a radial partial region of the shaft, which is located within an axial support region, forming an inner bearing ring of the at least one radial rolling bearing and defining at least one support element, and with a radial interlocking of the at least one support element of the shaft with at least one additional element providing for at least one additional function.

Because the additional means does not require that the shaft be formed with an additional axial region, which would have increase its length, the shaft can be made shorter. The smaller length of the shaft reduces the bending torques applied to its supports and generally reduces the axial length of the crank gear.

According to one of the preferred embodiments of the present invention, the shaft is formed as a drive shaft and includes a drive pinion which is provided at its end and forms, in the axial support region with its radially outer surface, the inner bearing ring of the at least one radial rolling bearing and forms with its coaxial radially inner surface, a bore in which a shaft end of another drive shaft engages force—or formlockingly. Advantageously, the another drive shaft is a rotor shaft of the electrical drive of the electrical hand-held power tool.

The crank gear, advantageously further includes a crank shaft having a coaxial bearing journal defining one point at which the crank shaft is supported, when mounted in the housing of the electrical hand-held power tool, and a further radial rolling bearing for supporting the crank shaft at another support point spaced from the one support point. A tooth gear is connected with the crank shaft and cooperates with the drive pinion for transmitting a rotational movement to the crank shaft. The tooth gear is located radially inwardly of the further radial rolling bearing in a plane of the further radial rolling bearing, and a radially outer region of the tooth gear forms an outer bearing ring of the further radial rolling bearing. The crank shaft has an eccentric section and axially extending eccentric journal provided on the eccentric section.

In another embodiment, the tooth gear has a circular groove the inner surface of which forcelockingly surrounds the outer bearing ring of the further radial rolling bearing.

In accordance with a further advantageous embodiment of the present invention, the shaft is formed as a crank shaft having an eccentric section and axially extending eccentric journal provided on the eccentric section, with the eccentric section forming an inner bearing ring of the at least one radial rolling bearing. There is further provided a radial rolling bearing supporting the crank shaft and spaced from at least one radial rolling bearing, and a tooth gear for transmitting rotational movement to the crank shaft and located between the at least one and further radial rolling bearings.

The tooth gear cooperates with a gear unit for transmitting rotational movement to a chuck of the electrical hand-held power tool.

According to the present invention, at least one of the crank shaft, the eccentric section of the crank shaft, and the drive pinion are formed without an undercut with respect to its rotational axis. This permits to form the respective element or elements using an extrusion process.

The novel features of the present invention, which are considered as characteristic for the invention, are set forth in the appended claims. The invention itself, however, both as to its construction and its mode of operation, together with additional advantages and objects thereof, will be best understood from the following detail description of preferred embodiments, when read with reference to the accompanying drawings.

### BRIEF DESCRIPTION OF THE DRAWINGS

The drawings show:

FIG. 1 shows a cross-sectional view of a first embodiment of a crank gear according to the present invention for percussion mechanism of an electrical hand-held power tool;

FIG. 2 shows a cross-sectional view of a second embodiment of a crank gear according to the present invention for a percussion mechanism of an electrical hand-held power tool; and

FIG. 3 shows a cross-sectional view of a third embodiment of a crank gear according to the present invention for a percussion mechanism of an electrical hand-held power tool.

### DETAILED DESCRIPTION OF THE PREFERRED EMBODIMENT

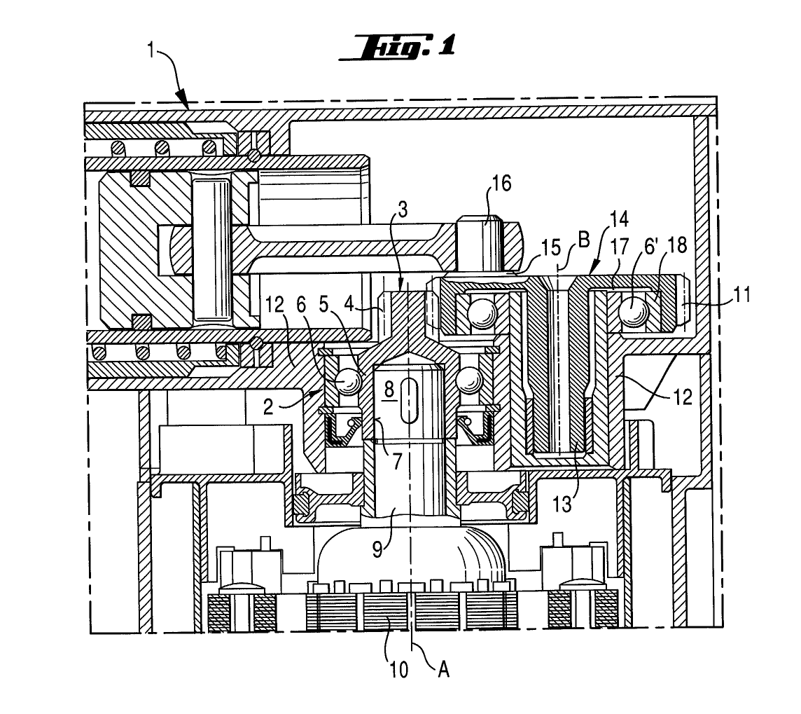

A crank gear according to the present invention for an electropneumatic percussion mechanism 1, which is only partially shown in FIG. 1 that shows a first embodiment of the inventive crank gear, includes a drive shaft 3 which is located in an axial support region 2 and is provided at its end with a drive pinion 4 fixedly secured thereon. A radial region of the drive pinion 4 of the drive shaft 3 forms an inner bearing ring 5 of a radial ball bearing 6 that supports the drive shaft 3. The drive shaft 3 has an inner bore 7 coaxial with the inner bearing ring 5 and in which a shaft end 8 of a rotor shaft 9 of an electrical drive 10 of an electrical hand-held tool forcelockingly engages. The drive pinion 4 drives, via a tooth gear 11, a crank shaft 14 which is supported in a housing 12 of the electrical hand-held power tool. The crank shaft 14 is supported in a radial ball bearing 6¹ at one of its end and at its bearing neck 13 spaced from the radial ball bearing 6¹. The radial ball bearing 6¹ is arranged in the plane of the tooth gear 11 radially inwardly of the tooth gear 11. At the end surface of the crank shaft 14, there is provided an eccentric section 15 that includes an eccentric journal 16 projecting axially outwardly with respect to the end surface of the crank shaft 14. The tooth gear 11 has, at its side opposite the eccentric journal 16, a circular groove 17 the inner surface of which forcelockingly encompasses the outer bearing ring 18 of the radial ball bearing 6¹. Both the drive pinion 4 and the crank shaft 14 are formed without an undercut with respect to their rotational axes A and B, respectively.

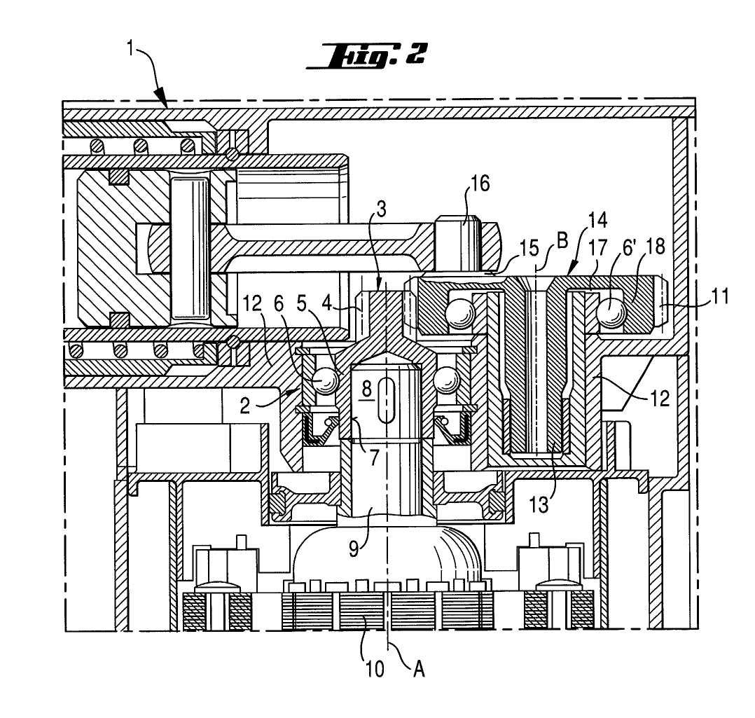

The embodiment of the inventive crank gear, which is shown in FIG. 2, is substantially similar to that shown in FIG. 1. As in the embodiment shown in FIG. 1, the drive pinion 4 drives, via a tooth gear 11, a crank shaft 14 which is supported in a housing 12 of the electrical hand-held power tool. The crank shaft 14 is supported in a radial ball bearing 6¹ at one of its end and at its bearing neck 13 spaced from the radial ball bearing 6¹. The radial ball bearing 6¹ is arranged in the plane of the tooth gear 11 radially inwardly of the tooth gear 11. As in the embodiment of FIG. 1, at the end surface of the crank shaft 14, there is provided an eccentric section 15 that includes an eccentric journal 16 projecting axially outwardly with respect to the end surface of the crank shaft. The embodiment of an inventive crank gear shown in FIG. 2 differs from that of FIG. 1 in that the radially outer region of the tooth gear 11 forms the outer bearing ring 18 of the radial ball bearing 6¹.

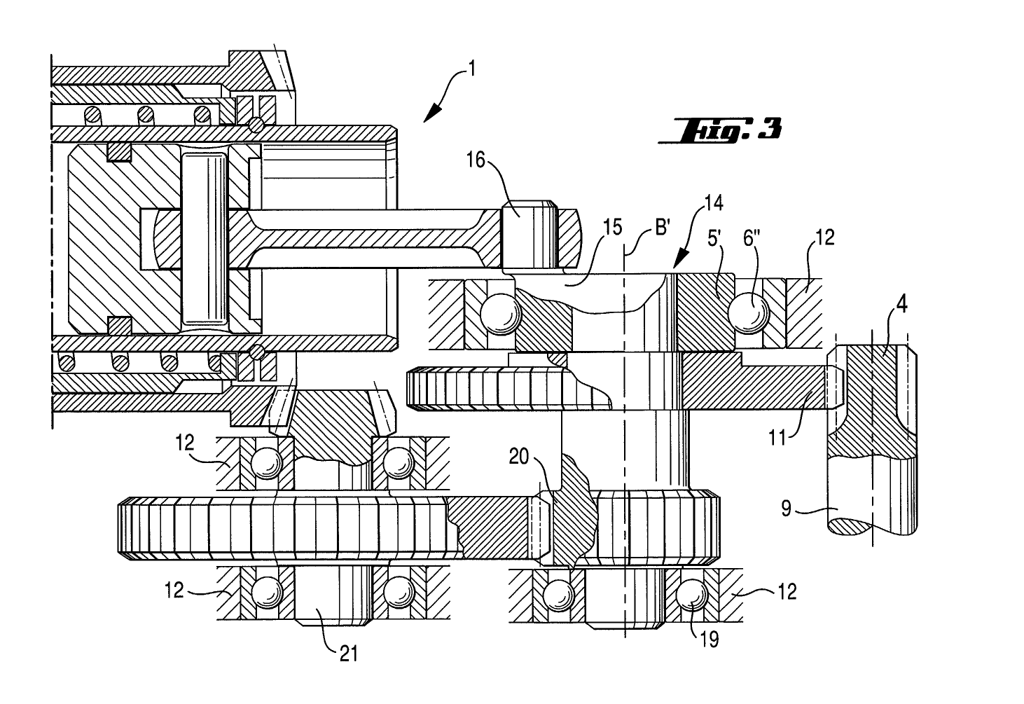

In the embodiment of an inventive crank gear shown in FIG. 3, the radially outer region of the eccentric section 15 of the crank shaft 14 forms an inner bearing ring 5¹ of a radial ball bearing 6¹. The tooth gear 11 which, in the embodiment shown in FIG. 3, is located between a radial ball bearing 6¹ and another bearing 19, cooperates with a gear unit 20 that transmit a torque to a rotary shaft 21 that transmit rotation to the tool spindle of the electrical hand-held power tool. As in the previous embodiments, the eccentric section 15 is formed without an undercut with respect to its rotational axis B¹.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claim is:

1. A crank gear for a pneumatic percussion mechanism of an electrical hand-held power tool, the crank gear comprising a shaft (3, 14); and at least one radial rolling bearing (6, 6′) for supporting the shaft (3, 14),
wherein a radial partial region of the shaft (3, 14), which is located within an axial support region (2), forms an inner bearing ring (5, 5¹, 18) of the at least one radial rolling bearing (6, 6¹) defining at least one support element, and
wherein a radial interlocking of the at least one support element of the shaft (3, 14) with at least one additional element (8, 11, 15) provides for at least one additional function.

2. A crank gear according to claim 1, wherein the shaft (3) is formed as a drive shaft and includes a drive pinion (4) provided at an end thereof and forming, in the axial support region (2), with a radially outer surface thereof, the inner bearing ring (5) of the at least one radial rolling bearing (6), and with its coaxial radially inner surface, a bore(7) in which a shaft end (8) of another drive shaft engages.

3. A crank gear according to claim 2, wherein another drive shaft is a rotor shaft (9) of an electrical drive (10) of the electrical hand-held power tool.

4. A crank gear according to claim 2, further compromising a crank shaft (14) having a coaxial bearing journal (13) defining one point at which the crank shaft (14) is supported, when mounted in the housing (12) of the electrical hand-held power tool; a further radial rolling bearing (6¹) for supporting the crank shaft (14) at another support point thereof spaced from the one support point, and a tooth gear (11) connected with the crank shaft (14) and cooperating with the drive pinion (4) for transmitting rotational movement to the crank shaft (14),
wherein the tooth gear (11) is located radially inwardly of the further radial rolling bearing (6¹) in a plane of the further radial rolling bearing (6¹), with a radially outer region of the tooth gear (11) forming an outer bearing ring (18) of the further radial rolling baring (6¹), and
wherein the crank shaft (14) has an eccentric section (15) and an axially extending eccentric journal (16) provided on the eccentric section (15).

5. A crank gear according to claim 2, further compromising a crank shaft (14) having a coaxial bearing journal (13) defining one point at which the crank shaft (14) is supported, when mounted in the housing (12) of the electrical hand-held power tool; a further radial rolling bearing (6¹) for supporting the crank shaft (14) at another support point thereof spaced from the one support point, and a tooth gear (11) connected with the crank shaft (14) and cooperating with the drive pinion (4) for transmitting rotational movement to the crank shaft (14),
wherein the tooth gear (11) is located radially inwardly of the further radial rolling bearing (6¹) in a plane of the further radial rolling bearing (6¹) and has, on an inner surface thereof, a circular groove inner wall of which forcelockingly surrounds the further radial rolling baring (6¹), and
wherein the crank shaft (14) has an eccentric section (15) and an axially extending eccentric journal (16) provided on the eccentric section (15).

6. A crank according to claim 1, wherein the shaft (14) is formed as a crank shaft and has an eccentric section (15) and an axially extending eccentric journal (16) provided on the eccentric section, and wherein the eccentric section (15) forms an inner bearing ring (5¹) of the at least radial rolling bearing (6¹).

7. A crank gear according to claim 6, further comprising a radial rolling bearing (19) supporting the crank shaft and spaced form the at least one radial rolling bearing (6), and a tooth gear (11) for transmitting rotational movement to the crank shaft (14) and located between the at least one (6¹) and further (19) radial rolling bearings.

8. A crank gear according to claim 7, wherein the tooth gear (11) cooperates with a gear unit (20) for transmitting rotational movement to a chuck of the electrical hand-held power tool.

9. A crank gear according to claim 4, wherein at least one of the crank shaft (14), the eccentric section (15) of the crank shaft (14), a and the drive pinion (4) are formed without an undercut with respect to a rotational axis thereof (A, B, B¹).
